(19) United States
(12) Patent Application Publication
(10) Pub. No.: US 2019/0146108 A1
(43) Pub. Date: May 16, 2019

(54) SYSTEM AND METHOD FOR ASSESSING THE PRESENCE OF HYDROCARBONS IN A SUBTERRANEAN RESERVOIR BASED ON SEISMIC DATA

(71) Applicant: CHEVRON U.S.A. INC., San Ramon, CA (US)

(72) Inventor: James R. MAGILL, Walnut Creek, CA (US)

(21) Appl. No.: 15/973,611

(22) Filed: May 8, 2018

Related U.S. Application Data
(60) Provisional application No. 62/503,427, filed on May 9, 2017.

(51) Int. Cl. G01V 1/28; G01V 1/30; G01V 1/34

(52) U.S. Cl. CPC G01V 1/282; G01V 1/306; G01V 1/345; G01V 2210/74; G01V 2210/614; G01V 2210/665; G01V 2210/632

(57) ABSTRACT

A method is described for a manner of geologic analysis using seismic data. The method includes steps to produce improved amplitude versus angle (AVA) information that may be used for analysis of geologic features of interest including estimation of pore fluid content and quantitative probabilities of different fluid contents and/or rock properties. The method assesses the probability of hydrocarbons in a subterranean reservoir based on seismic amplitude variations along offsets or angles for portions of a seismic horizon. The method may be executed by a computer system.

### CROSS-REFERENCE TO RELATED APPLICATIONS

This application claims the benefit of U.S. Provisional Patent Application 62/503,427 filed May 9, 2017.

### STATEMENT REGARDING FEDERALLY SPONSORED RESEARCH OR DEVELOPMENT

Not applicable.

### TECHNICAL FIELD

The present disclosure relates generally to methods and systems for probabilistic analysis of geologic features using seismic data and, in particular, methods and systems for assessing the probability of hydrocarbons or rock properties in a subterranean reservoir based on seismic amplitude variations along offsets or angles for portions of a seismic horizon.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation and other properties.

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

In some cases, it is desirable to analyze the recorded seismic amplitudes. This may be done in many ways. One step in conventional processing of seismic reflection data involves adding multiple seismic traces that share a common mid-point, but have different source-receiver offsets. This is commonly called “stacking”. Stacking generally improves the signal to noise ratio, but can result in ambiguity surrounding the cause of the seismic amplitudes. For example, a high seismic amplitude could indicate either the presence of fluids or the presence of a particular lithology.

One conventional technique that can provide an improved method of delineating between lithology and fluids is employment of amplitude versus offset (AVO) or angle (AVA) for a representative offset/angle gather. Those of skill in the art would be aware that amplitude versus angle (AVA) is often used interchangeably with amplitude versus offset (AVO).

During processing, this type of AVA data may not be stacked thereby to preserve information that can be used to distinguish indicators of fluids from indicators of lithology. For example, considering a seismic trace, in one scenario, a hydrocarbon-bearing sand may generally have an increasingly negative seismic amplitude at further source-receiver offsets compared to a water-bearing sand which may be indicated by a decrease in positive seismic amplitude at further source-receiver offsets.

The above methods may however often be biased and may not truly represent the geologic features. In addition, conventional methods may fail where seismic data quality is low, such as where random and/or coherent noise is prevalent, or where seismic gathers are not flat. The ability to define the location of rock and fluid property changes in the subsurface is crucial to our ability to make the most appropriate choices for purchasing materials, operating safely, and successfully completing projects. Project cost is dependent upon accurate prediction of the position of physical boundaries and fluid content within the Earth. Decisions include, but are not limited to, budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

There exists a need for seismic processing methods capable of producing improved AVA information that may be used for analysis of geologic features of interest.

### SUMMARY

In accordance with some embodiments, a method of rock property assessment in a subterranean volume of interest including receiving a digital image representative of a subsurface volume of interest and a range of geological and geophysical parameters possible in the subsurface volume of interest; identifying at least one spatial area of interest; calculating measured seismic amplitude versus angle (AVA) responses from the digital seismic image in each of the at least one spatial area; calculating statistical data ranges of the measured seismic AVA responses based on the measured AVA responses; forward modeling, all combinations of the geological and geophysical parameters to generate a set of synthetic seismic AVA responses; and estimating fluid and/or lithologies and probabilities of different fluids and/or lithologies within at least one spatial area of interest based on the statistical data ranges of the measured seismic AVA responses and the synthetic seismic AVA responses is disclosed.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates a flowchart of a method of analyzing geologic features using seismic data, in accordance with some embodiments;

FIG. 2 is an example of one step from an embodiment;

FIGS. 3-6 are examples of other steps from various embodiments;

FIGS. 7-8 are examples of other steps and results from embodiments;

FIG. 9 summarizes two embodiments;

FIGS. 10-11 are examples of other steps and results from embodiments; and

FIG. 12 is a block diagram illustrating a subsurface assessment system, in accordance with some embodiments.

Like reference numerals refer to corresponding parts throughout the drawings.

### DETAILED DESCRIPTION OF EMBODIMENTS

Described below are methods, systems, and computer readable storage media that provide a manner of geologic analysis using seismic data. These embodiments are designed to calculate probabilities of hydrocarbons (i.e. fluid property estimation) and/or rock properties in subsurface geologic features. Industry standard techniques use deterministic estimation of the underlying geologic and geophysical parameters which contribute to the amplitude versus angle response utilizing forward modeling or inversion. The subsurface parameters of interest are the thickness, pore fluid (brine, oil, gas), hydrocarbon saturation, porosity, lithology, etc. The present method combines probabilistic AVA/AVO (amplitude versus angle/amplitude versus offset) and spatial summation of amplitude versus offset gathers with a Bayesian analysis to determine the range of geologic and geophysical parameters that will fit a user-selected range of measured field responses from selected areas. The probabilistic estimation builds a model space with a regular grid, then a singular bin is located for a given seismic trace and the property estimation is based on counting models in that singular bin. The range of possible models can be selected as either those models where the downdip responses fit a brine-filled reservoir and the updip responses fit a fluid-filled reservoir (the fluid being brine, oil, or gas), or those models where the updip responses fit a fluid-filled reservoir (with no accounting for the downdip response), or both. The present invention allows boxes based on the seismic data to be defined in the model space based on the probabilistic analysis from which the property estimation is done by counting models in the boxes. In the description herein, the terms fluid, pore fluid, and fluid content are used interchangeably, as those of skill in the art understand that the fluids contained in a subsurface reservoir are within the pore space of the reservoir formation.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

Seismic imaging of the subsurface is used to identify potential hydrocarbon reservoirs. Seismic data is acquired at a surface (e.g. the earth's surface, ocean's surface, or at the ocean bottom) as seismic traces which collectively make up the seismic dataset. The seismic dataset may be processed and imaged via a pre-stack method in order to analyze the seismic amplitude versus angle (AVA) or offset (AVO).

The present invention includes embodiments of a method and system for assessing rock properties in a subterranean reservoir to determine the probability of hydrocarbons. Rock properties may include at least one of pore fluid content, porosity, water saturation, hydrocarbon composition, pressure, temperature, reservoir thickness, mineralogical composition (e.g. Vₛₕₐₗₑ), or any combination thereof. Determining the most probable rock properties in a geologic feature and a range of possible rock properties allows strategic planning around budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment, as well as ultimately drilling into an optimum location to produce the hydrocarbons.

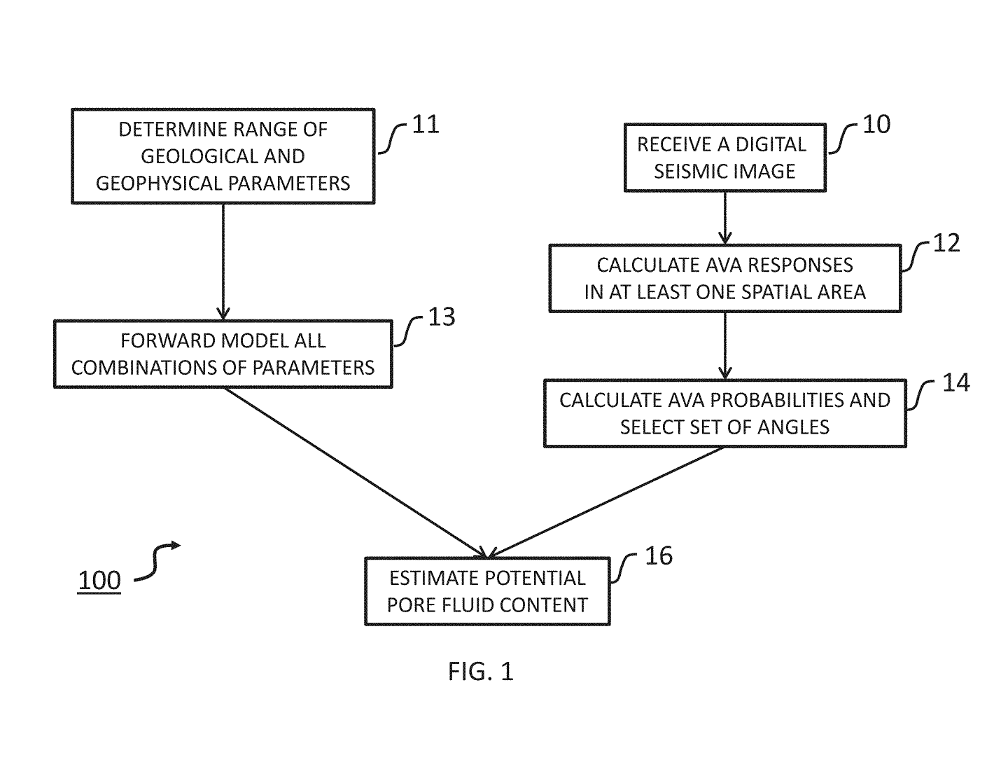

FIG. 1 illustrates a flowchart of a method 100 for geologic analysis of a subsurface volume of interest. At operation 10, a digital seismic image is received. As previously described, a seismic dataset includes a plurality of traces recorded at a plurality of seismic sensors. This dataset may have already been subjected to a number of seismic processing steps, such as deghosting, multiple removal, spectral shaping, and the like, before undergoing a seismic imaging process. These examples are not meant to be limiting. Those of skill in the art will appreciate that there are a number of useful seismic processing steps that may be applied to seismic data and seismic images. The digital seismic image received 10 may be, for example, a pre-stack seismic image, one or more seismic angle stacks, or one or more digital seismic horizon amplitude maps. The seismic horizon amplitude maps may have been computed at a series of angles (or summation of adjacent angles) in place of migrated seismic gathers. The seismic amplitude maps are computed by extracting the seismic amplitude from the migrated seismic gathers (either exact amplitude, or a computation of seismic amplitude at times above and/or below the horizon computed as average, absolute, rms, maximum, minimum, or other computational method) at the interpreted horizon time.

At operation 12, the seismic amplitude versus angle (AVA) responses are calculated in at least one spatial area identified in the seismic image on at least one seismic horizon. This may be done, for example, using the method of U.S. Pat. No. 9,817,142, System and Method for Analyzing Geologic Features Using Seismic Data, which is incorporated herein in its entirety. A pre-stack seismic image contains multiple seismic horizons that represent seismic events identified or selected, in an embodiment, by a user as being of interest. These seismic horizons may represent a single lithology, such as a sand layer or a shale layer, or an interface within one or between two or more lithologies. If seismic horizon amplitude maps were received at operation 10, the seismic horizon(s) of interest are already identified.

The seismic horizons may be represented in time or depth, being optionally flattened on one or more of the horizons. As is known, flattening of seismic data is used to remove the influence of geological processes such as folding and faulting in one or more the lithological interfaces from the data, enabling images produced from the seismic data to be processed into horizontal layers, e.g., for easier interpretation. The flattening of seismic data is an optional step.

The seismic image and seismic horizons received may be two-dimensional (2-D) (e.g., a horizontal dimension “x” and a time or depth dimension “z”) or three-dimensional (3-D) data sets (e.g., two perpendicular horizontal dimensions “x” and “y” and a time or depth dimension “z”).

In an embodiment, two or more areas of interest are identified on the seismic horizons. In an embodiment using 3-D data, the areas of interest may be identified on a map view of the one or more seismic horizons, e.g., as polygons, wherein the map view may be colored (or shaded or contoured) to indicate the seismic amplitudes along the particular horizon.

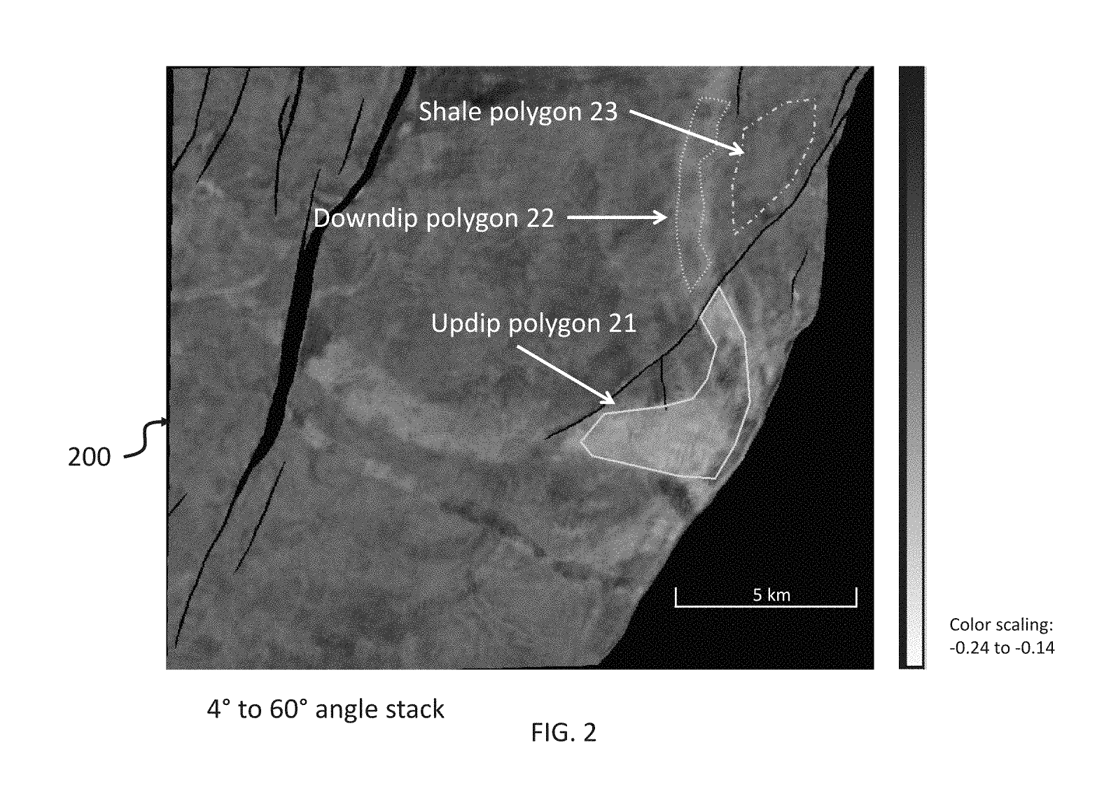

One example of a map view of a seismic horizon, including a seismic amplitude legend to the side thereof, is shown in FIG. 2. In order to create this map view 200, a full range of seismic amplitude data has been stacked, which in this example embodiment is seismic amplitude data between angles 4° and 60°, as part of a data preprocessing step. The map indicates different regions of varying seismic amplitudes (indicated in differing shades) mostly correlating with the distribution of lithology, as well as liquids and gas, e.g., hydrocarbons. These differences in seismic amplitude across the chosen angle range are used to delineate the specific areas of interest. The areas of interest may be selected through analysis of the data or may be received as inputs from the user.

In this example of FIG. 2, an updip polygon is chosen in an area of general negative seismic amplitude, see reference numeral 21, and may, e.g., represent the crest of an upwardly slanting layer of rock, i.e., the pinnacle of an anticline (or updip). This indicates, in this particular example, a location where gas or oil are most likely to be found.

Usually and if present, oil or water would occur in a downdip or downslope position with respect to the updip polygon 21. In the particular example of FIG. 2, a downdip polygon 22 is therefore chosen in an area with a seismic amplitude generally higher (i.e. less negative) than that of the updip area 21.

As is evident from FIG. 2, a shale polygon 23 may also optionally be chosen in an area with a seismic amplitude generally lower in absolute amplitude than both the updip and downdip polygons 21, 22. It may be necessary to take additional information relating to a trend of the dip into account when choosing a particular polygon, e.g., the shale polygon 23 may be chosen furthest away from the updip polygon 21.

It would be appreciated by a person skilled in the art that this example is not meant to be limiting and that other seismic amplitude variations may correspond to different structural configurations and locations of gas, oil, or water. For example, in other embodiments, the updip polygon representing a location where gas or oil are located may be chosen in an area of positive (and high) seismic amplitude, while the downdip polygon representing locations of oil or water may be chosen in an area of negative (and low) seismic amplitude. Although the terms “updip” and “downdip” are used herein to identify and differentiate between the polygons containing the spatial areas of interest, this example is likewise not meant to be limiting. In some embodiments, the polygons are intended to identify at least two areas that are suspected to have different fluid contents but the actual structural relationship may vary. By way of example and not limitation, the structural relationship may be two areas separated by a fault.

In some embodiments, each area of interest may encase a large number of seismic trace locations. In terms of the present disclosure, it is important to include a sufficient number of seismic trace locations (resulting in a sufficient number of seismic traces or data sets to be processed) thereby to ensure statistical stability of the resulting AVA curves. By way of example and not limitation, a sufficient number of seismic trace locations may be on the order of thousands of trace locations.

The statistical data ranges are influenced and determined by a range of geology enclosed in the selected area of interest (i.e. polygon) and noise. The range of geology may include, for example, changes in thickness, porosity, grain size, cementation, mineralogical composition, or the like. Statistical stability of the data is ensured by making the area of interest (polygon) sufficiently large to ensure that the noise is averaged out, as well as large enough to contain a representative sampling of the geology.

Referring again to FIG. 1, in operation 14 statistical data ranges are computed for the seismic amplitudes in each of the areas of interest, shown in the example of FIG. 2 as updip, downdip and shale polygon 21, 22 and 23. These computations and calculations may be performed by reading seismic angle gathers, i.e. all of the seismic traces at a particular angle for an area of interest, identifying a time gate centered on the seismic horizon, and computing the aggregated amplitudes at each angle. The time gate has the effect of isolating a portion of each selected trace around a feature of interest in time. This process of computing the statistical data ranges for the seismic amplitudes in each of the areas of interest is computationally expensive. Operation 14 may also identify a set of angles or angle ranges representative of shape of the curves; in some cases only one angle may be used, or all angles included in the curves may be used, or any other number in between.

A person skilled in the art would appreciate that the computation and calculations of statistical data ranges can be performed using pre-stack seismic data in depth coordinates, rather than time coordinates, and identifying a depth gate centered on the seismic horizon.

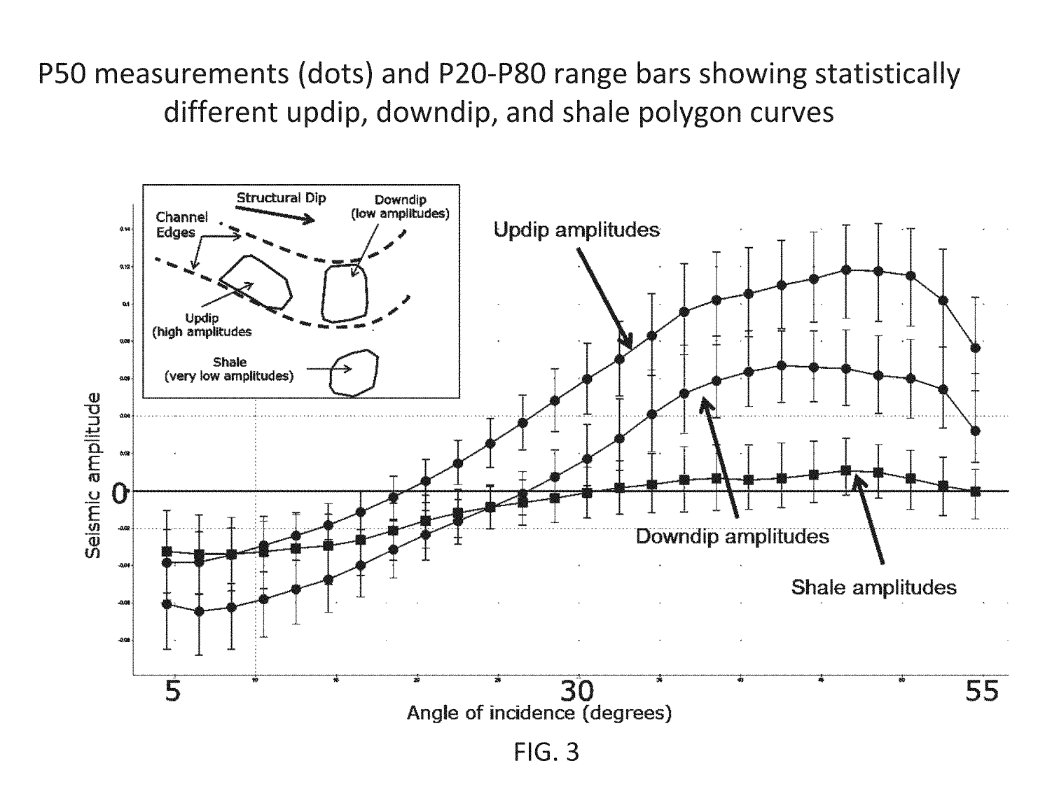

In terms of the present method it is advantageous to calculate the probability of various seismic amplitudes within the area of interest, thereby allowing the statistical data ranges of seismic amplitudes to be determined. In some embodiments, the statistical data ranges may be represented by P50 and an upper and a lower probabilistic value for seismic amplitudes, each of the upper and lower values being similarly offset from the P50 value. For example, the upper and lower probabilistic values may respectively be selected as a P10 and a P90 probabilistic value, a P20 and a P80 probabilistic value, a P30 and a P70 probabilistic value, or the like. These values are provided by way of example only and are not meant to be limiting. FIG. 3 shows an example of P50 curves calculated for an updip, downdip, and shale polygon with P20-P80 range bars.

Typically, the P50 probabilistic value represents the underlying signal, while the upper and lower probabilistic values are indicative of a probabilistic range which represents the variable geology and/or noise. A variety of statistics may be computed from the aggregated seismic amplitudes, i.e. in addition, or alternatively, to the probabilistic values mentioned above. For example, the statistical data ranges may include one or more of an average or mean (such as an average absolute amplitude), a mode, RMS (root-mean-square), or a standard deviation. It will be appreciated that other statistical measures may also be used. The use of many seismic trace locations from the areas of interest may assist in obtaining statistically significant data, in that the data may be more stable and distinct.

In addition, in another embodiment, angle stacks may be created by summing the seismic traces for each time or depth sample at two or more angles, e.g., adjacent angles (such as 1-2°, 2-3°, 3-4°, or 15-25°, 25-35°, etc.). A normalization based on the number of traces summed may be used in order to obtain an optimum presentation of the results. In other words, these angle stacks may in some instances stabilize the trend of the AVA curves produced. It will however be appreciated that in many cases there may be no need for this type of stacking. As an alternative to using the AVA responses at particular angles or angle stacks, the statistical data ranges may be based on other criteria such as the gradient or rate of change of the seismic amplitude response with angle or other industry-recognized measurements in the field (e.g., fanfar, grenv).

Referring again to FIG. 1, at operation 11 the method 100 determines possible ranges of geological and geophysical parameters expected in the reservoir zone being analyzed that affect the seismic amplitude versus angle response. The expected ranges of geological and geophysical parameters are determined by the user based on nearby known information (e.g., previously drilled wells), estimated from theoretical equations, or other such information sources to provide results which may best characterize the expected geological and geophysical parameters expected in the reservoir zone. These parameters may include brine composition, hydrocarbon composition, pressure, temperature, porosity, reservoir thickness, mineralogical composition, and other factors. These determinations may be done by regional analysis, geologic inference or analogs, petrophysical analysis from analog well logs, or other means. Those of skill in the art will be aware that there are a number of ways of determining reasonable ranges of geological and geophysical parameters for a particular subterranean volume.

Geological parameters may be determined, for example, for a situation in which there is advance knowledge of the deposition environment of the material. In this case, that knowledge may allow the user to determine information regarding what types of materials are likely to be present as well as what relationship various layers are likely to have. By way of example, an eolian deposition environment would tend to include sandstones that are relatively free of clay and relatively well-sorted. In contrast, deltaic sandstones would tend to be higher in clay content. In order to render the hypothetical physical properties more relevant to the analysis of the acquired seismic data, the types of sandstone generated would depend, at least in part, on whether the region under investigation includes wind-deposited or river delta deposited material and could be further differentiated based on specifics of the deposition environment. Geophysical parameters may be determined, for example, where there is local information available, such as from well cores or well logs from nearby wells.

Once the ranges of possible geological and geophysical parameters are determined, operation 13 proceeds to perform a full range of forward modeling, typically 2-layer or 3-layer modeling with more layers added in complex subsurfaces, with all combinations of the geological and geophysical parameters. This may be done, for example, using a method such as that described in U.S. Pat. No. 7,869,955, Subsurface Prediction Method and System, which is incorporated herein in its entirety. By way of example and not limitation, pseudo-wells including multiple types of synthetic well logs may be generated. Pseudo-wells may include physical properties such as Vp, Vs, density, porosity, shale volume (Vshale), or other properties. In an embodiment, each pseudo-well may be generated with a wet (brine) sand, then that “parent” pseudo-well may be replicated with different fluid contents, such as oil, gas, or fizz (low saturation, non-commercial amount of gas in the formation brine water), resulting in multiple pseudo-wells that only vary in fluid content.

The pseudo-wells may be generated using a partially random approach. Rather than using a simple stochastic approach, in which any particular physical model is equally likely, the generation of the pseudo-wells may be constrained by physical constraints. The constraining may take place prior to the generating, or alternately, purely stochastic pseudo-wells may be later constrained (e.g., by eliminating wells having characteristics outside the constraints). As will be appreciated, it is likely to be more efficient to first constrain, then generate, the wells, but either approach should be considered to be within the scope of the present invention.

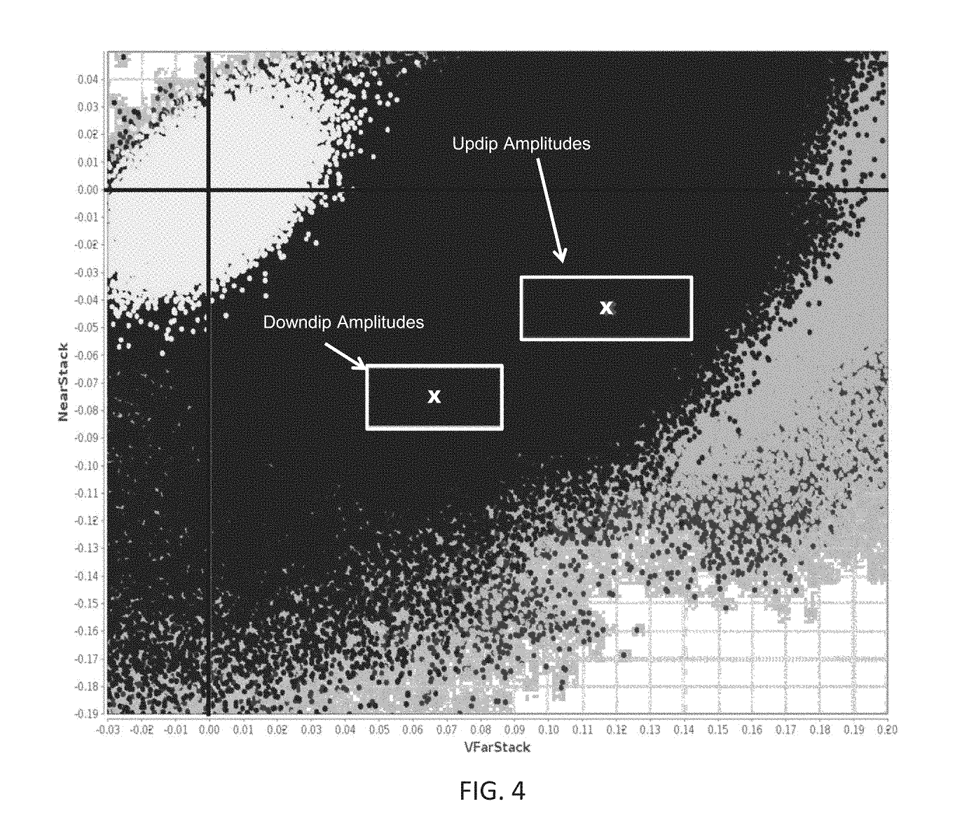

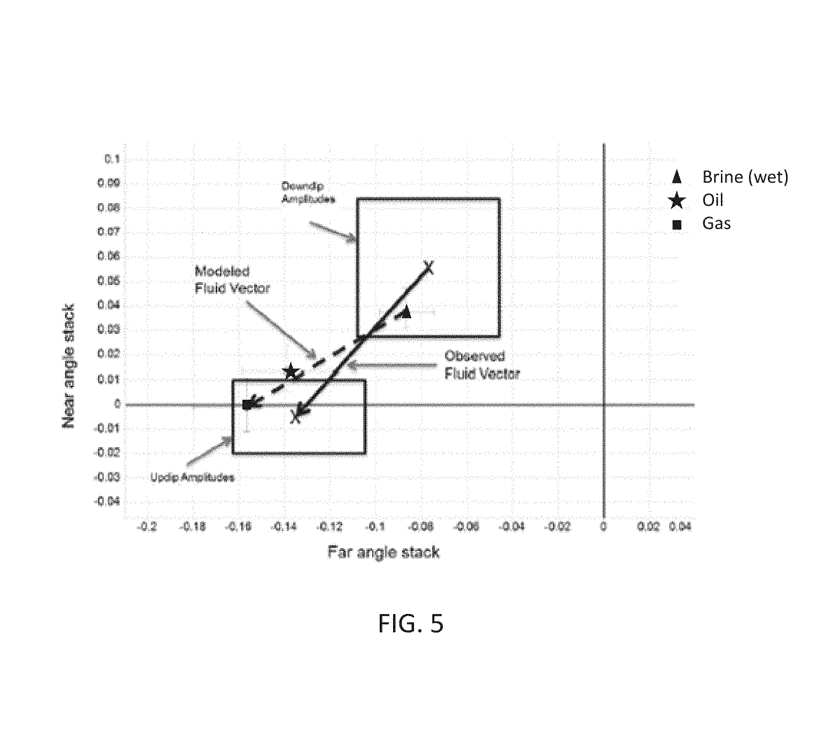

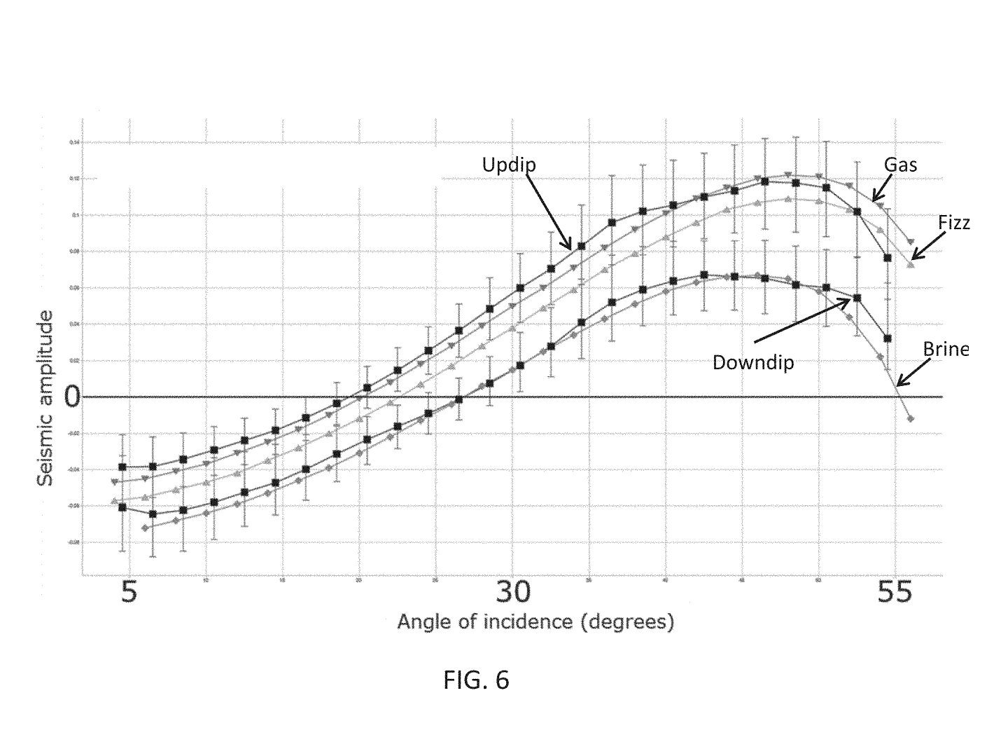

The forward modeling of operation 13 will produce modeled (i.e. synthetic) seismic gathers containing AVA effects for the various combinations of geological and geophysical parameters. Forward modeling may be done, for example, using some form of the Zoeppritz equation, full waveform modeling, or other such seismic modeling method that may be appropriate including that explained by U.S. Pat. No. 7,869,955. The modeled seismic gathers will be labeled with the geological and geophysical properties used for the pseudo-wells that were subjected to forward modeling. The AVA responses should be determined separately for brine, low and high hydrocarbon saturation, and different hydrocarbon fluids. The modeled AVA response (i.e., seismic gathers) will be labeled with the geological and geophysical properties used for the pseudo-wells that were subjected to forward modeling. The labels allow the measured response ranges to be optionally segregated by different geological assessment of the mineralogical composition of the reservoir and non-reservoir rocks (i.e. facies) simulated in the forward modeling step. Other examples of the forward modeled responses can be seen in FIG. 4. In FIG. 4, the different grayscale dots indicate amplitudes as very-far-stack vs. near-stack for different fluid contents in different facies combinations. In an embodiment, the forward modeling may not use different facies combinations but will be for different fluid contents. Boxes defining the updip amplitudes and downdip amplitudes are based on the AVA probabilities calculated in operation 14, calculated from the input digital seismic image, are shown. FIG. 5 shows a similar plot of the updip and downdip boxes but the forward modeled results have been simplified to the modeled fluid vector rather than the grayscale dots. To one skilled in the art, it would obvious that instead of defining a box around the P50 amplitudes at each measured angle to represent the range of seismic amplitudes, one could also use an ellipse or other such shape to represent the spatial distribution of the data about the central value. Alternatively, a mathematical distribution characterizing the distribution of the data around the P50 amplitude could be estimated and used from operation 14 and forward in the analysis. Moreover, although FIG. 5 shows the box in two dimensions, the box (or ellipse or mathematical distribution) may be multi-dimensional. For example, if statistical data ranges are found for four different angles, the box would have four dimensions. FIG. 6 is an example of a single forward-modeled pseudowell, modeled for three different fluid contents (gas, fizz, and brine) as compared to the statistical data ranges determined from the input digital seismic image in the updip and downdip polygons.

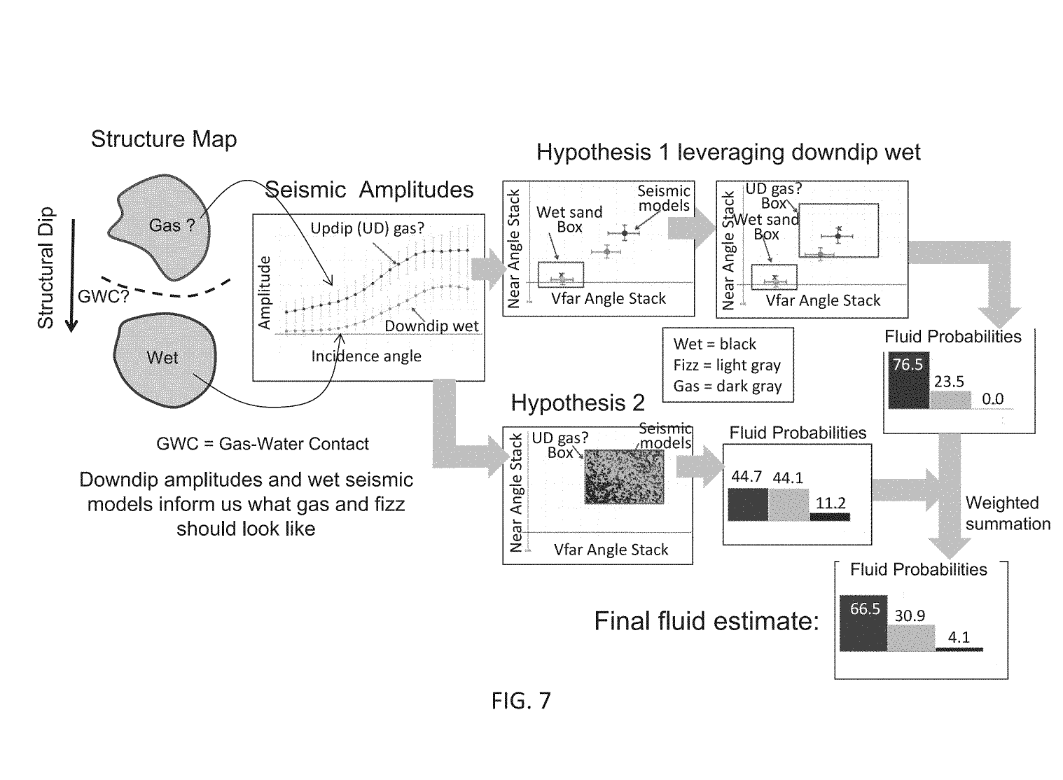

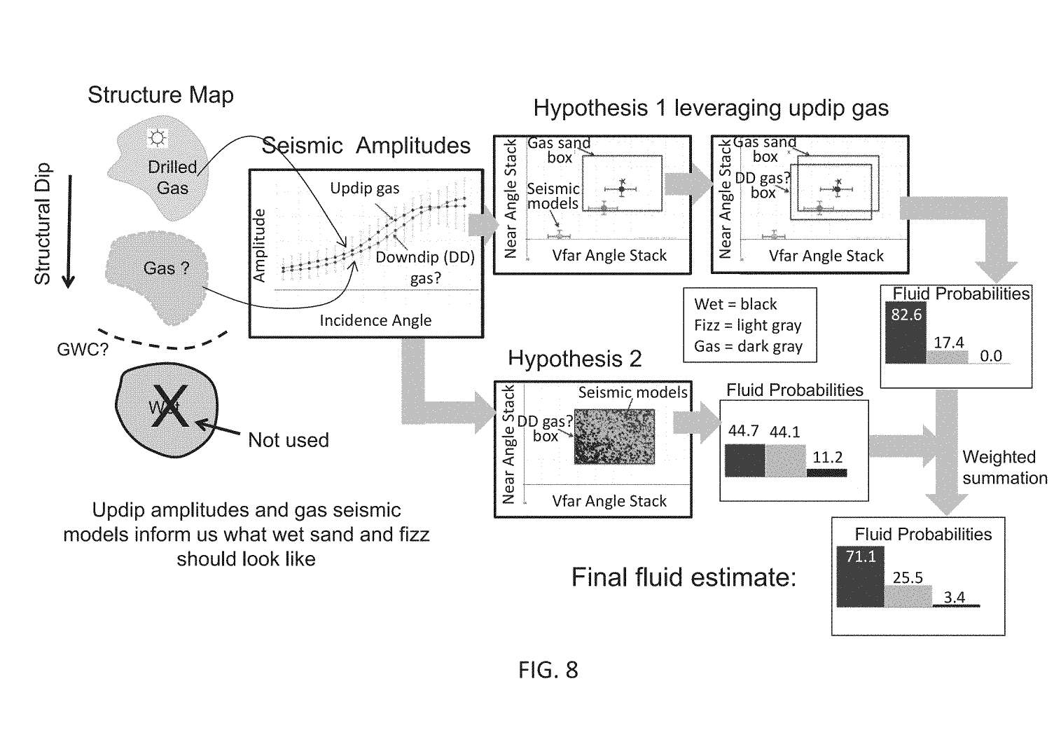

Method 100 can now proceed to operation 16, estimating the potential pore fluid content based on comparison of the calculated AVA probabilities from operation 14 and the calculated modeled AVA responses from operation 13. This estimation is done by considering two different hypotheses for AVA behavior between the two different spatial areas (e.g., the updip and downdip areas). By way of example, these hypotheses may be taken as:
1. Hypothesis 1 assuming downdip brine—this hypothesis assumes that the downdip and updip areas have the same wet sand properties therefore any difference in the measured seismic amplitude versus angle responses in the corresponding downdip and updip boxes would be due to a different pore fluid. This version of hypothesis 1 further assumes that the downdip fluid is brine. This is demonstrated in FIG. 7. The downdip wet hypothesis is preferred for use in exploration, where few if any wells may exist. It may be analyzed by first determining the number of forward model responses that represent a brine-filled reservoir that have responses which fit into a box centered on the P50 response at each measured parameter and an extent determined by the user-selected range. The successful models must have a calculated response which fits all of the measured response ranges for each of the set of angles or angle ranges selected at operation 14. Next determine from this sub-class of forward model responses, those models which have a calculated response in the updip box centered on the P50 response at each measured parameter and an extent determined by the user-selected range. The pore fluid considered in the models which fit the updip box response may be brine, or any of the hydrocarbon fluid combinations considered in the forward modeling step. It is possible to perform this determination because of the way pseudo-wells are generated in operation 13—a “parent” pseudo-well for a particular set of geological and geophysical parameters is replicated with different fluid contents, such as gas, fizz, and brine, resulting in multiple pseudo-wells that only vary in fluid content. Once the models that fit in the updip box for any of the fluid contents and fit in the brine downdip box, the total number of these forward model responses is summed. The probability of each pore fluid in the updip box according to this hypothesis is the number of successful response for that pore fluid divided by the total number of successful responses.
2. Hypothesis 1 with known updip hydrocarbons—this hypothesis again assumes that the downdip and updip areas have the same wet sand properties therefore any difference in the measured seismic amplitude versus angle responses in the corresponding downdip and updip boxes would be due to a different pore fluid. This version of hypothesis 1 further assumes that the updip box has a known hydrocarbon fluid (i.e., a well has been drilled and encountered gas or oil). This is demonstrated in FIG. 8. It may be analyzed by first determining the number of forward model responses that represent a hydrocarbon filled reservoir have responses which fit into a box centered on the P50 response at each measured parameter and an extent determined by the user-selected range. The successful models must have a calculated response which fits all of the measured response ranges for each of the set of angles or angle ranges selected at operation 14. Next determine from this sub-class of forward model responses, those models which have a calculated response in the downdip box centered on the P50 response at each measured parameter and an extent determined by the user-selected range. The pore fluid considered in the models which fit the downdip box response may be brine, or any of the hydrocarbon fluid combinations considered in the forward modeling step. It is possible to perform this determination because of the way pseudo-wells are generated in operation 13—a “parent” pseudo-well for a particular set of geological and geophysical parameters is replicated with different fluid contents, such as gas, fizz, and brine, resulting in multiple pseudo-wells that only vary in fluid content. Once the models that fit in the downdip box for any of the fluid contents and fit in the known hydrocarbon updip box, the total number of forward model responses which fit both the downdip box and updip box criteria is summed. The probability of each pore fluid in the downdip box according to this hypothesis is the number of successful response for that pore fluid divided by the total number of successful responses. The known updip hydrocarbon case requires at least one well and can be used for appraisal and development of hydrocarbon fields, including estimating fluid probabilities in adjacent, undrilled fault blocks.
3. Hypothesis 2—the downdip and updip areas have different or unrelated rock properties so there is no assumed relationship between the measured seismic amplitude versus angle responses between the downdip and updip boxes, therefore the downdip area is not used. This is demonstrated in the lower path of FIG. 7 and FIG. 8. This hypothesis may be analyzed by determining the subset of modeled seismic amplitude versus angle responses that fit the updip box for each pore fluid. The box is centered on the P50 measured response at each measured parameter and an extent also calculated by the statistical data ranges, for example the P20-P80 range. The successful models must have a calculated response which fits all of the measured response ranges. The pore fluid considered in the models which fit the updip box response may be brine, or any of the hydrocarbon fluid combinations considered in the forward modeling step. Sum the total number of forward model responses which fit the updip box criteria. The probability of each pore fluid in the updip box according to this hypothesis is the number of successful response for that pore fluid divided by the total number of successful responses.

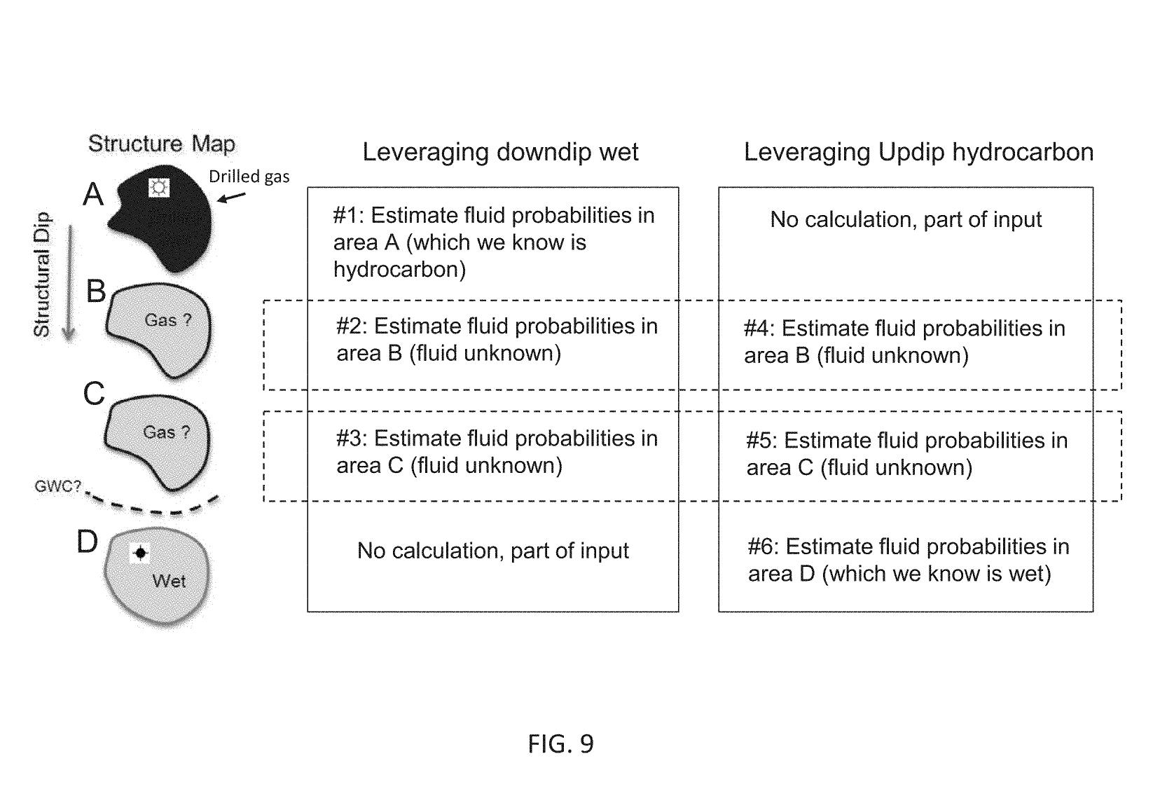

A summary of the assumed downdip wet case and the known updip hydrocarbon case is shown in FIG. 9. Here, there are 4 regions A-D, with A being the highest on the structure and D being the lowest on the structure. A possible gas/water contact (GWC) is indicated. For either the assumed downdip wet or the known updip hydrocarbon cases, the regions B and C have unknown fluid content and the processes described above can be used to estimate the probabilities of various fluids, as shown in FIGS. 7 and 8, respectively. In the assumed downdip wet case, region D is presumed to be wet (brine) and fluid probabilities can be calculated for region A. In the known updip hydrocarbon case, region A is known and the fluid probabilities in region D can be estimated. Those of skill in the art can also see that these methods can be modified to estimate fluid probabilities in regions updip or downdip from regions B or C, if these regions are drilled into.

The hypotheses may be combined (one or the other version of hypothesis 1 combined with hypothesis 2) to estimate an overall fluid probability for the reservoir. When combining the two hypotheses, it is necessary to normalize the results so they can be combined in a meaningful way. There are numerous methods to execute the normalization. In one such method, the total count for Hypothesis 1 (Wet seismic models in downdip box and gas or fizz or wet models in updip box) and the total count for Hypothesis 2 (Seismic models in updip box) are normalized. After normalization, the models that fit Hypothesis 1 and the normalized number of models that fit Hypothesis 2 are added together with equal weighting or some other user-selected weighting between the hypotheses. If there exists a prior probability estimate of the pore fluid in the updip polygon, the probability of the pore fluid in the updip polygon may be updated based on the analysis above via Bayesian inference. In a different embodiment, the normalization may normalize the two hypotheses based on equal parent populations. The parent populations are the maximum possible counts. Those skilled in the art can appreciate that there may be other methods to normalize the information from Hypothesis 1 and Hypotheses 2 than may be outlined here.

Although the embodiment above focused on fluid estimation, a similar analysis can be used for lithology estimation. By way of example and not limitation, the lithology estimation may calculate the probability of sand versus the probability of shale. In this case, the labels associated with the synthetic seismic gathers generated in operation 13 would include lithology for each seismic model. The lithology would be estimated as described above for the fluid estimation. It is also possible to perform joint estimation of fluid and lithology, for example estimating the probability of a spatial area being gas sand, wet sand, or shale.

Seismic models which are consistent with hypothesis 1 or hypothesis 2 can also be used to estimate rock properties in addition to fluid. This can be done using the labels associated with the synthetic seismic gathers generated in operation 13. The estimated rock properties may include porosity, reservoir thickness, mineralogical composition such as V_{Shale}, net to gross (fraction of reservoir volume occupied by hydrocarbon-bearing rocks), pressure, temperature, or any combination thereof. These estimated rock properties are estimates of the average geology in the spatial area of interest. Rock properties, such as porosity, can be estimated independently for hypothesis 1 and hypothesis 2, or can be combined for both hypotheses using the normalization procedure as was outlined above for fluid estimation.

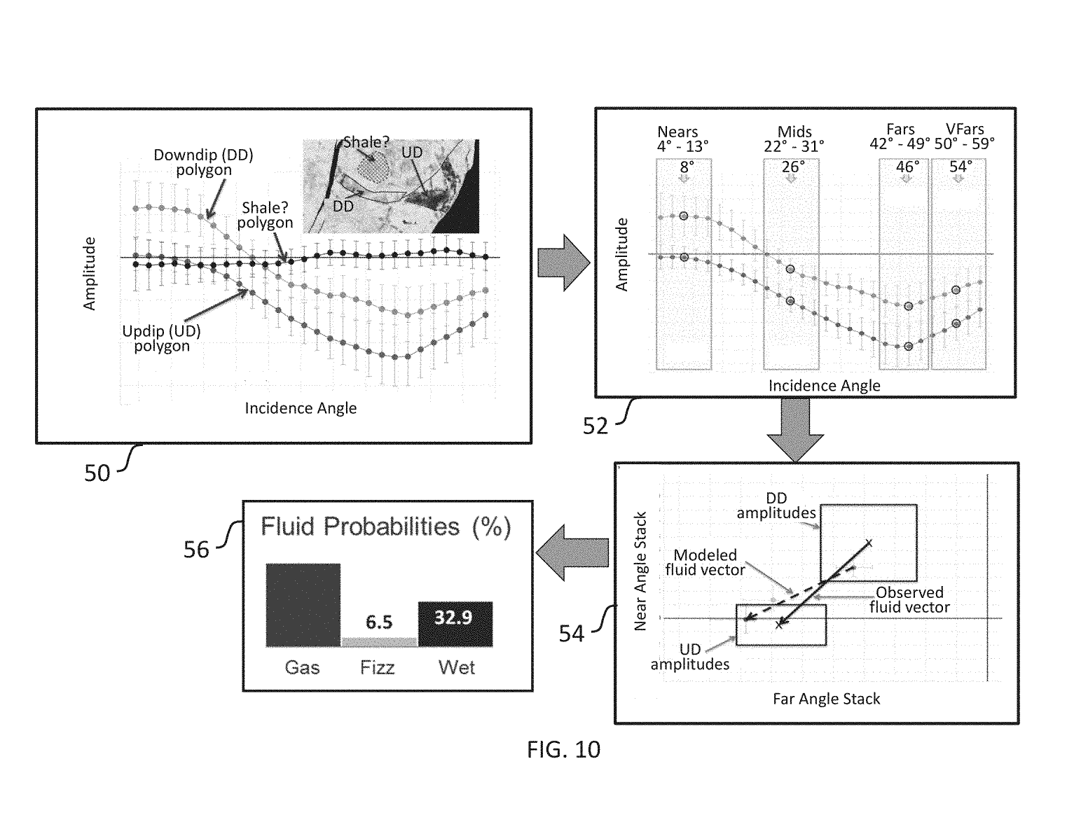

FIG. 10 is an example of the steps of method 100. Diagram 50 shows AVA probability curves created at operation 14 of method 100. Diagram 52 shows the AVA probability curves with angle ranges selected for use in subsequent steps of method 100. In this example, four angle ranges have been stacked (summing amplitude values of adjacent angles in the range) to represent the near angle, mid angle, far angle, and very far angles. This is not meant to be limiting; although four angles may be representative of the curves, in some cases only one angle may be used, or all angles included in the curves may be used, or any other number in between. Diagram 54 demonstrates the comparison of downdip and updip boxes and the measured P50 and modeled fluid vectors which is part of operation 16 of method 100. Note that diagram 54 shows only two dimensions (the near angle and far angle) but in reality, there are as many dimensions for this plot as there are angles selected from diagram 52; in this example, there are four dimensions. Chart 56 shows the resulting probabilities of fluid content for this example, also part of operation 16. Note that although this example estimated fluid probabilities, this method may also be used to estimate rock properties (including lithology, pressure, temperature, porosity, reservoir thickness, mineral composition including sand volume and shale volume) or combinations of fluid and rock properties. Although these results are displayed graphically, this is not meant to be limiting. Other methods of presenting the results, such as in a spreadsheet format, are possible.

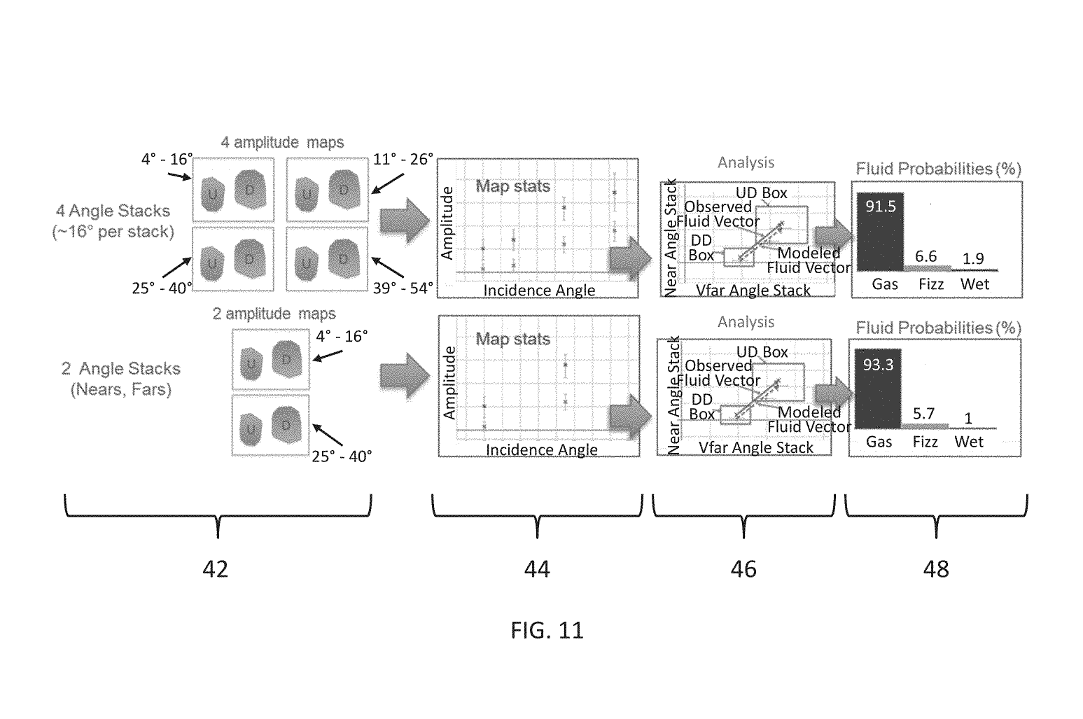

FIG. 11 illustrates an alternative input for the present invention. The digital seismic image received at operation 10 does not have to be arranged in seismic gathers but can instead be one or more amplitude maps. An example of method 100 using 4 different input amplitude maps (top row) and one example using 2 different input amplitude maps (bottom row) as shown in column 42. For the top example, the seismic dataset was stacked over angles 4-16, 11-26, 25-40, and 39-54 degrees and the amplitude maps were each generated for the same horizon. For the bottom example, the seismic dataset was stacked over angles 4-16 and 25-40 degrees and the amplitude maps were each generated for the same horizon. These examples are not meant to be limiting. Any range of angle stacks may be created and any number of amplitude maps may be created. Column 44 shows the statistical data ranges calculated for the two examples. Column 46 shows the analysis of the AVA probabilities from the seismic image and forward modeling. Column 48 shows the estimated pore fluid content probabilities.

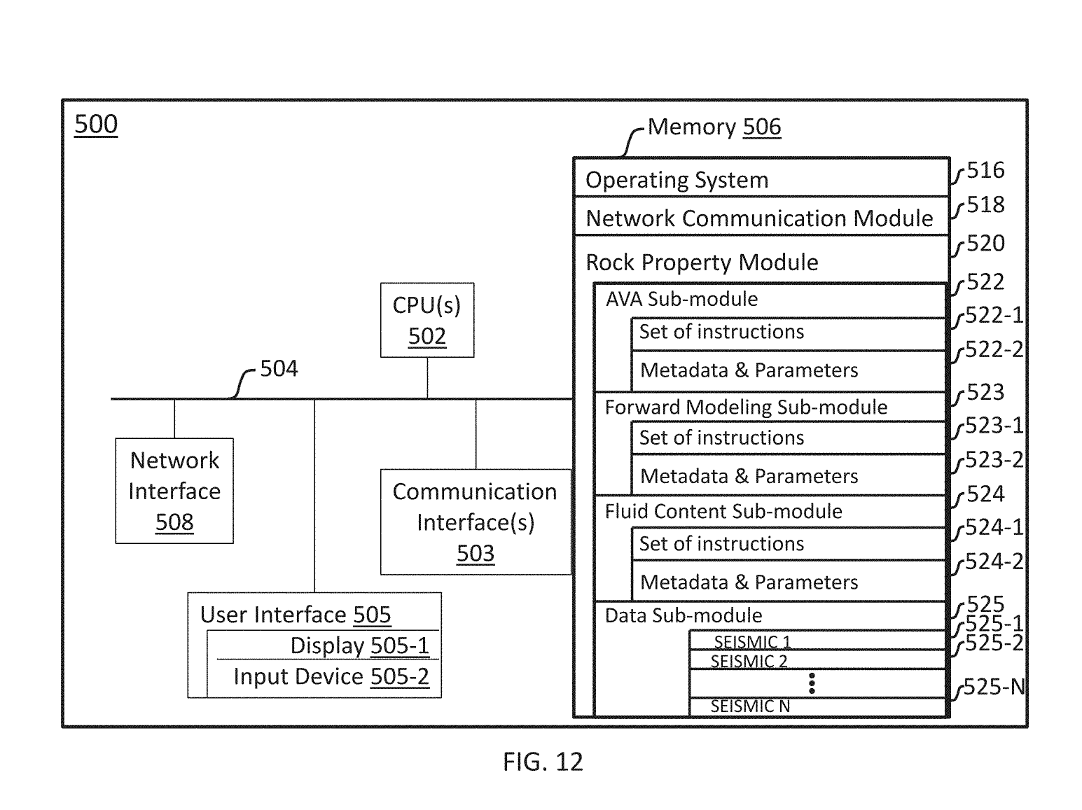

FIG. 12 is a block diagram illustrating a fluid assessment system 500, in accordance with some embodiments. While certain specific features are illustrated, those skilled in the art will appreciate from the present disclosure that various other features have not been illustrated for the sake of brevity and so as not to obscure more pertinent aspects of the embodiments disclosed herein.

To that end, the rock property assessment system 500 includes one or more processing units (CPUs) 502, one or more network interfaces 508 and/or other communications interfaces 503, memory 506, and one or more communication buses 504 for interconnecting these and various other components. The rock property assessment system 500 also includes a user interface 505 (e.g., a display 505-1 and an input device 505-2). The communication buses 504 may include circuitry (sometimes called a chipset) that interconnects and controls communications between system components. Memory 506 includes high-speed random-access memory, such as DRAM, SRAM, DDR RAM or other random access solid state memory devices; and may include non-volatile memory, such as one or more magnetic disk storage devices, optical disk storage devices, flash memory devices, or other non-volatile solid-state storage devices. Memory 506 may optionally include one or more storage devices remotely located from the CPUs 502. Memory 506, including the non-volatile and volatile memory devices within memory 506, comprises a non-transitory computer readable storage medium and may store seismic data, velocity models, seismic images, and/or geologic structure information.

In some embodiments, memory 506 or the non-transitory computer readable storage medium of memory 506 stores the following programs, modules and data structures, or a subset thereof including an operating system 516, a network communication module 518, and a rock property module 520.

The operating system 516 includes procedures for handling various basic system services and for performing hardware dependent tasks.

The network communication module 518 facilitates communication with other devices via the communication network interfaces 508 (wired or wireless) and one or more communication networks, such as the Internet, other wide area networks, local area networks, metropolitan area networks, and so on.

In some embodiments, the fluid assessment module 520 executes the operations of method 100. Rock property module 520 may include data sub-module 525, which handles the seismic image including seismic gathers 525-1 through 525-N. This seismic data is supplied by data sub-module 525 to other sub-modules.

AVA (amplitude versus angle) sub-module 522 contains a set of instructions 522-1 and accepts metadata and parameters 522-2 that will enable it to execute operation 12 and 14 of method 100. The forward modeling function sub-module 523 contains a set of instructions 523-1 and accepts metadata and parameters 523-2 that will enable it to execute operation 13 of method 100. The fluid content sub-module 524 contains a set of instructions 524-1 and accepts metadata and parameters 524-2 that will enable it to execute at least operation 16 of method 100. Although specific operations have been identified for the sub-modules discussed herein, this is not meant to be limiting. Each sub-module may be configured to execute operations identified as being a part of other sub-modules, and may contain other instructions, metadata, and parameters that allow it to execute other operations of use in processing seismic data and generate the seismic image. For example, any of the sub-modules may optionally be able to generate a display that would be sent to and shown on the user interface display 505-1. In addition, any of the seismic data or processed seismic data products may be transmitted via the communication interface(s) 503 or the network interface 508 and may be stored in memory 506.

Method 100 is, optionally, governed by instructions that are stored in computer memory or a non-transitory computer readable storage medium (e.g., memory 506 in FIG. 12) and are executed by one or more processors (e.g., processors 502) of one or more computer systems. The computer readable storage medium may include a magnetic or optical disk storage device, solid state storage devices such as flash memory, or other non-volatile memory device or devices. The computer readable instructions stored on the computer readable storage medium may include one or more of: source code, assembly language code, object code, or another instruction format that is interpreted by one or more processors. In various embodiments, some operations in each method may be combined and/or the order of some operations may be changed from the order shown in the figures. For ease of explanation, method 100 is described as being performed by a computer system, although in some embodiments, various operations of method 100 are distributed across separate computer systems.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of rock property assessment in a subterranean volume of interest, comprising:
a. receiving, at a computer processor, a digital image representative of a subsurface volume of interest and a range of geological and geophysical parameters possible in the subsurface volume of interest;
b. identifying one or more spatial areas of interest;
c. calculating, via the computer processor, measured seismic amplitude versus angle (AVA) responses from the digital seismic image in each of the one or more spatial areas;
d. calculating, via the computer processor, statistical data ranges of the measured seismic AVA responses based on the measured AVA responses;
e. forward modeling, via the computer processor, all combinations of the geological and geophysical parameters to generate a set of synthetic seismic AVA responses;
f. presenting, to a user interface, one or more plots of the statistical data ranges of the measured seismic AVA responses and the set of synthetic seismic AVA responses; and
g. graphically distinguishing, in the one or more plots, geologic features of the subsurface within the one or more spatial areas of interest based on the statistical data ranges of the measured seismic AVA responses and the set of synthetic seismic AVA responses by quantitatively analyzing the synthetic seismic AVA responses to identify fluid features and lithology features located in the subterranean volume of interest and conduct fluid estimation, lithology discrimination and/or analysis, structural conformance, well-planning and/or reservoir management, or any combination thereof.

2. The method of claim 1 further comprising using the fluid features and lithology features to determine a well location and drill a well to produce hydrocarbons.

3. The method of claim 1 further comprising generating quantitative probabilities of fluid content based on the statistical data ranges of the measured seismic AVA responses and the set of synthetic seismic AVA responses and graphically displaying the quantitative probabilities of fluid content.

4. The method of claim 1 further comprising generating quantitative probabilities of rock properties based on the statistical data ranges of the measured seismic AVA responses and the set of synthetic seismic AVA responses and graphically displaying the quantitative probabilities of rock properties.

5. The method of claim 1 wherein the fluid features and the lithology features include at least one of pore fluid content, porosity, pressure, temperature, porosity, reservoir thickness, mineralogical composition, or any combination thereof.

6. The method of claim 1 wherein the digital image is a pre-stack seismic image including seismic gathers.

7. The method of claim 1 wherein the digital image includes one or more angle stack seismic cubes, wherein each angle stack seismic cube represents a different angle or summed angle range.

8. The method of claim 1 wherein the digital image includes one or more seismic horizon amplitude maps, wherein each seismic horizon amplitude map represents a different angle or summed angle range.

9. The method of claim 1 wherein the statistical data ranges of the measured seismic AVA responses are represented by a P50 probabilistic value, and an upper and lower probabilistic value for seismic amplitudes, the upper and lower probabilistic value being similarly offset from the P50 value.

10. The method of claim 1 wherein at least two spatial areas of interest with substantially similar lithologies are identified and wherein the quantitatively analyzing includes assuming that any differences in the measured seismic AVA responses in the at least two spatial areas are due to a different pore fluid.

11. The method of claim 10 wherein one of the spatial areas of interest is assumed to contain brine pore fluid.

12. The method of claim 10 wherein one of the spatial areas of interest is assumed to contain hydrocarbon pore fluid.

13. The method of claim 1 wherein one spatial area of interest is identified as an updip area and the quantitatively analyzing includes analysis of the updip area.

14. The method of claim 1 wherein at least two spatial areas of interest with substantially similar lithologies are identified; wherein one of the spatial areas of interest is identified as an updip area; and wherein the quantitatively analyzing includes a normalized combination of a calculation assuming that any differences in the measured seismic AVA responses in the at least two spatial areas are due to a different pore fluid and an analysis of the updip area.

15. A computer system, comprising:
one or more processors;
memory; and one or more programs, wherein the one or more programs are stored in the memory and configured to be executed by the one or more processors, the one or more programs including instructions that when executed by the one or more processors cause the device to:
receive, at the one or more processors, a digital image representative of a subsurface volume of interest and a range of geological and geophysical parameters possible in the subsurface volume of interest;
identify one or more spatial areas of interest;
calculate, via the one or more processors, measured seismic amplitude versus angle (AVA) responses from the digital seismic image in each of the one or more spatial areas;
calculate, via the one or more processors, statistical data ranges of the measured seismic AVA responses based on the measured AVA responses;
forward model, via the one or more processors, all combinations of the geological and geophysical parameters to generate a set of synthetic seismic AVA responses;
present, to a user interface, one or more plots of the statistical data ranges of the measured seismic AVA responses and the set of synthetic seismic AVA responses; and
graphically distinguish, in the one or more plots, geologic features of the subsurface within the one or more spatial areas of interest based on the statistical data ranges of the measured seismic AVA responses and the set of synthetic seismic AVA responses by quantitatively analyzing the synthetic seismic AVA responses to identify fluid features and lithology features located in the subterranean volume of interest and conduct fluid estimation, lithology discrimination and/or analysis, structural conformance, well-planning and/or reservoir management, or any combination thereof.

16. A non-transitory computer readable storage medium storing one or more programs, the one or more programs comprising instructions, which when executed by an electronic device with one or more processors and memory, cause the device to:
receive, at the one or more processors, a digital image representative of a subsurface volume of interest and a range of geological and geophysical parameters possible in the subsurface volume of interest;
identify one or more spatial areas of interest;
calculate, via the one or more processors, measured seismic amplitude versus angle (AVA) responses from the digital seismic image in each of the one or more spatial areas;
calculate, via the one or more processors, statistical data ranges of the measured seismic AVA responses based on the measured AVA responses;
forward model, via the one or more processors, all combinations of the geological and geophysical parameters to generate a set of synthetic seismic AVA responses;
present, to a user interface, one or more plots of the statistical data ranges of the measured seismic AVA responses and the set of synthetic seismic AVA responses; and
graphically distinguish, in the one or more plots, geologic features of the subsurface within the one or more spatial areas of interest based on the statistical data ranges of the measured seismic AVA responses and the set of synthetic seismic AVA responses by quantitatively analyzing the synthetic seismic AVA responses to identify fluid features and lithology features located in the subterranean volume of interest and conduct fluid estimation, lithology discrimination and/or analysis, structural conformance, well-planning and/or reservoir management, or any combination thereof.
